(19) United States
(12) Patent Application Publication
(10) Pub. No.: US 2024/0410098 A1
(43) Pub. Date: Dec. 12, 2024

(54) COVER CLEANING APPARATUS

(71) Applicant: Kyle Lange, Richfield, UT (US)

(72) Inventor: Kyle Lange, Richfield, UT (US)

(21) Appl. No.: 18/739,008

(22) Filed: Jun. 10, 2024

Related U.S. Application Data
(60) Provisional application No. 63/472,157, filed on Jun. 9, 2023.

(51) Int. Cl. D06F 7/02; A47G 9/02

(52) U.S. Cl. CPC D06F 7/02; A47G 9/0238

(57) ABSTRACT

While the described cover cleaner can include any suitable component that allows it to clean a cover, in some cases, the cover cleaner includes a retractor configured to selectively couple with, selectively retract, and selectively release a cover, and a cleaner coupled to the retractor and configured to clean the cover while the retractor retracts the cover. Other implementations are described.

### RELATED APPLICATIONS

This application claims priority to U.S. Provisional Application No. 63/472,157 (Attorney Docket No. 34620.2), entitled “COVER CLEANING APPARATUS”, and filed on Jun. 9, 2023, which is incorporated herein by reference in its entirety.

### FIELD

The described systems relate to fabrics and other coverings, and more particularly to a cleaning or storage device for a fabric or other cover, such as a towel, an article of clothing, a piece of linen, a bedcover, or any other sheet, fabric, material, or other cover. While the described device can include any suitable component that allows it to clean or store a cover, in some cases, the device includes a retractor that is configured to selectively couple with, selectively retract, or selectively release a cover. In some cases, the device includes a cleaner that is coupled to the retractor and that is configured to sanitize or otherwise clean the cover while the retractor retracts or releases the cover.

### BACKGROUND

Traditionally, the task of cleaning covers, such as bedcovers (e.g., bedsheets, blankets, coverlets, bedspreads, comforters, quilts, duvets, and any other suitable material configured to cover a sleeping area), fabrics and textiles (e.g., silk, denim, velvet, crepe chiffon, linen, flannel, cotton, polyester, wool, fleece, broadcloth, or any other textile material), drying implements (e.g., towels, hand towels, dish cloths, washcloths, rags, cleaning towels), clothing (e.g., shirts, pants, underwear, socks, hats, scarves, and other apparel), floor covers (e.g., rugs, carpets, fleeces, mats, and other floor covers), domestic covers (e.g., couch covers, chair covers, curtains, drapes, and other household covers) and other covers can be an arduous process. For example, cleaning bedcovers often involves gathering fabrics and linens, transporting the materials (e.g., in a laundry basket), washing the materials in a traditional washer, drying the materials (e.g., by hanging, air-drying, or using an electric or gas-powered dryer), folding the materials, transporting the materials back to the bed, and replacing the materials on the bed or putting the materials back in storage. Often, multiple sets of bedcovers must be used so that the bed is not bare while one set of bedcovers is being cleaned.

Thus, while there are existing techniques for cleaning covers (e.g., bedcovers, textiles, clothing, towels, rugs, and other covers) challenges still exist, including those listed above. For at least these reasons, there are significant limitations to some of the current technology in the cover cleaning industry. Thus, there is a need for improved systems and methods for cleaning covers.

### BRIEF SUMMARY

The described systems relate to the application of one or more cover cleaner systems. In particular, disclosed is a cover cleaner system that, in some cases, has one or more frames, mounts, support arms, retractors, rollers, cranks, motors, cleaners, connectors, actuators, support bars, debris removers, fasteners, clips, elastics, slits, heaters, misters, vibrators, covers, or any other suitable component or components.

In some implementations, the cover cleaner system includes one or more retractors. In some implementations, the retractor is coupled with, or is configured to selectively couple with, a cover (e.g., a bedcover). Some implementations of the retractor are configured to selectively retract the cover. In some cases, the retractor is configured to selectively release or selectively extend the cover.

According to some implementations, the cover cleaner system includes one or more cleaners (which can include, without limitation, one or more brushes, lint brushes, combs, vacuums, blowers, ultraviolet lights, heaters, dryers, fans, adhesives, or any other suitable type of cleaners). In some implementations, the cleaner is coupled to or otherwise used in association with the retractor and is configured to clean the cover while the retractor retracts or releases the cover.

In some instances, the retractor of the cover cleaner system includes one or more rollers supported by one or more suitable supports (e.g., one or more support arms).

In some cases, the cleaner of the cover cleaner system includes one or more cleaning heads that are coupled to one or more support bars or to any other suitable support.

According to some implementations, the cover cleaner system includes: one or more frames having one or more support arms; one or more retractors having one or more rollers supported by the one or more support arms; and one or more cleaners coupled to the retractor and having one or more cleaning heads. In accordance with some implementations, the retractor may selectively couple to a cover, and selectively retract the cover by causing the cover to coil around the roller. In some implementations, the cleaning head can clean the cover while the cover is being retracted.

According to some iterations, the frame of the cover cleaner system further includes one or more mounts for coupling the frame to a support or other surface. In some implementations, the cover cleaner device further includes one or more support bars that are coupled to the roller. In some implementations, the support bar supports the cleaning head.

In some implementations, the support bar (or bar) is moveable along one or more connectors. Further, in some cases, a position of the support bar with respect to the roller can be adjusted (e.g., by moving the support bar along the connector, by moving the connector, by adjusting the position of the support bar independently of the connector, or by adjusting the position of the support bar by any other means). In some implementations, such adjustment is accomplished manually. In some implementations, however, the position of the support bar is adjusted automatically. In some iterations, the position of the support bar is adjusted as a result of mechanical movement of the bar by one or more other components of the cover cleaner. Some implementations of the cover cleaner have one or more actuators for actuating the support bar along the connector or otherwise adjusting the position of the support bar. In some implementations, the actuator actuates the bar along the connector in a manner that maintains a fixed distance between the cleaning head and a first surface of the cover as the cover retracts by winding around the roller.

According to some implementations, the roller is coupled to one or more cranks such that when the crank is turned, the roller rotates about a longitudinal axis of the roller. Thus, if a cover is attached to the roller, the cover winds around the roller (or unwinds from the roller, if already wound and the crank is turned in the opposite direction). In some implementations, the roller is coupled to one or more motors, drivers, drive mechanisms, or other actuators, such as a motor or other actuator that is configured to rotate the roller about the longitudinal axis. Thus, the motor or actuator can replace or be used in addition to the crank. In some implementations, the crank or the motor is attached to a shaft that extends through the frame and connects to the roller, thereby causing the roller to rotate when the crank or the motor (or other actuator) is activated. In some implementations, the crank, the motor, or other actuator turns a gear that engages with the roller, thereby causing the roller to rotate when the crank, motor, or other actuator is activated.

In some implementations, the roller is supported by one or more support arms. In some implementations, the roller surrounds the support arm and interacts with the support arm loosely enough that the roller is free to rotate about a longitudinal axis while the support arm remains stationary. In some implementations, the support arm is coupled to the frame. In some cases, the support arm includes two or more separate support arms.

In some cases, while the roller rotates about the longitudinal axis, a cover is wound around the roller. In some instances, while the cover is wound around the roller, a first surface of the cover comes into contact with, or is otherwise acted upon by, the cleaning head. For example, in some implementations, the cleaning head includes one or more brushes, which are configured to brush matter off of (or collect matter from) the first surface of the cover while the cover is wound around the roller. As an example, the brush can come into contact with the first surface of the cover, and the rotating movement of the roller can move the first surface of the cover across the brush, thereby causing the brush to remove matter from the cover.

Some iterations of the cleaning head include one or more vacuums configured to remove matter from the cover. In some instances, the cleaning head includes one or more lint rollers (e.g., one or more adhesive lint rollers or any other suitable type of lint rollers) configured to remove matter from the cover. According to some implementations, the cleaning head includes one or more static-electric cleaning devices, and in some implementations, the cleaning head includes one or more misters configured to spray mist or any other suitable fluid onto the cover. Such mist (or other fluid) can include water, cleaning chemicals, odorants, starch, or any other suitable type of fluid. In some iterations, the cleaning head includes one or more steamers (e.g., to remove wrinkles from, sanitize, or to freshen the cover). In some implementations, the cleaning head includes one or more heaters that are configured to heat the cover. Such heating can be of a sufficient degree to: sterilize the cover; to kill a bacteria, fungi, parasites, fleas, mites, or other biologics disposed on or in the cover; or simply warm the cover to make it more comfortable for a user. In some cases, the cleaning head includes one or more vibrators that allow the cleaning head to more deeply clean the cover (e.g., by vibrating debris from the cover).

In some implementations, the cleaning head includes one or more cleaning rollers (such as a lint roller). In some cases, the cleaning roller is configured to rotate in the opposite direction as the roller. For example, if the cleaning roller comprises an adhesive lint roller, the lint roller may be coupled to the roller such that when the roller rotates, the lint roller rotates in a direction opposite to the direction of rotation of the roller. In some cases, the cleaning roller has a separate crank, motor, or other actuator to drive its rotation. Some versions of the cleaning roller are coupled to the roller through one or more rotation mechanisms (such as through the use of one or more rotation mechanisms using gears, wheels, belts, chains, or any other suitable feature comprising one or more rotating components) that cause the cleaning roller to automatically rotate in the opposite direction as the roller when the roller is rotated. In some implementations, the roller and the cleaning roller are configured to press or steam the cover as the cover is rolled around the roller, thereby ironing or removing wrinkles from the cover.

According to some implementations, the cover cleaner includes one or more fasteners for attaching a cover to the roller. In this regard, the fastener can comprise any suitable object or mechanism that is capable of coupling the cover to the roller. Indeed, in some implementations, the fastener comprises any suitable type of clip, such as a C-clip. In some implementations, the fastener includes one or more straps. In some implementations, the fastener includes one or more elastics. In some implementations, the fastener includes one or more hoses. In some implementations, the fastener includes one or more snaps, zippers, hook-and-loop fasteners (e.g., Velcro™ fasteners), magnets, or any other suitable type of fasteners. In some implementations, the fastener includes an aperture or slit in the roller into which an edge or any other suitable portion of a cover can be inserted. In some implementations, the aperture is only on one side of the roller, whereas, in some implementations the aperture is on both sides so that the edge of the cover can be passed entirely through the roller.

In some iterations, the actuator is configured to adjust the position of the support bar with respect to the roller such that the cleaning head is maintained at a fixed distance in proximity to the cover as the cover wraps around the roller. In some cases, the cleaning head is held in a position to contact the cover, whereas in other cases, the cleaning head is held at a fixed distance away from the cover.

In some implementations, the cover cleaner system includes a frame having a mount for coupling the frame to a surface and a support arm; a retractor having a roller supported by the support arm and configured to rotate about a longitudinal axis; a fastener configured to selectively attach an edge (or any other suitable portion) of a cover to the roller; and a cleaner having a first support bar coupled to the frame by a connector, with a first cleaning head coupled to the first support bar, wherein the first cleaning head is configured to clean a first surface of the cover when the roller rotates; and a second support bar coupled to the frame by the connector, with a second cleaning head coupled to the second support bar, wherein the second cleaning head is configured to clean a second surface of the cover when the roller rotates. Thus, the cover can pass between the two cleaning heads, and the top and bottom surfaces of the cover can be cleaned simultaneously.

In some implementations, the cover cleaner system includes an automation system. In some embodiments, the automation system causes the motor to drive the roller, the actuator to move the adjustable connector, the cleaning head to activate, or another part of the cover cleaner to function or change functions. In some implementations, the automation system includes one or more computers, processors, transponders, user interfaces, networks, system busses, timers, or other electronic units or devices that may be useful for automating one or more systems of the cover cleaner.

In some implementations, the motor (or other actuator) of the cover cleaner system is configured to drive the roller in response to receiving a signal from a timer or from a transponder. In some implementations, the actuator is configured to adjust the position of the support bar in response to receiving a signal. In some implementations, the cleaning head is configured to activate in response to receiving a signal.

While the described systems may be particularly useful in the area of cleaning bedcovers, clothing, household covers, and floor covers, those skilled in the art can appreciate that the described systems can be modified (e.g., by being resized, reshaped, or adapted in any other suitable manner) to be used in connection with any manner of sheetlike materials or other covers for many purposes, such as to clean or remove particular matter from curtains, clothing, medical bandages, rugs, mats, carpets, paper, plastic or metal sheets, tarps, textiles, towels, washcloths, twill, velvet, velour, voile or any other type of suitable cover.

These and other features and advantages of the described systems will be set forth or will become more fully apparent in the description that follows and in the appended claims. The features and advantages may be realized and obtained by means of the instruments and combinations particularly pointed out in the appended claims. Furthermore, the features and advantages of the described systems and methods may be learned by the practice thereof or will be evident from the description, as set forth hereinafter.

### BRIEF DESCRIPTION OF THE DRAWINGS

The objects and features of the described systems will become more fully apparent from the following description and appended claims, taken in conjunction with the accompanying drawings. Understanding that these drawings depict only typical embodiments and are, therefore, not to be considered limiting of its scope, the described systems will be explained with additional specificity and detail through the use of the accompanying drawings in which:

FIG. 1A shows a front perspective view of a cover cleaner system attached to a foot of a bed, in accordance with a representative embodiment;

FIG. 1B shows a front perspective view of the cover cleaner system attached to the foot of the bed, in accordance with a representative embodiment;

FIG. 1C shows a front perspective view of the cover cleaner system attached to a head of the bed, in accordance with a representative embodiment;

FIG. 2 shows a perspective view of the cover cleaner system, in accordance with a representative embodiment;

FIG. 3 shows a perspective view of the cover cleaner system with an alternative cleaning head, in accordance with a representative embodiment;

FIG. 4 shows a perspective view of the cover cleaner system with multiple cleaning heads, in accordance with a representative embodiment;

FIG. 5 shows a side elevation view of the cover cleaner system used in connection with bedding components, in accordance with a representative embodiment;

FIGS. 6A-6B show side elevation views of a frame of the cover cleaner system having various actuation mechanisms, in accordance with representative embodiments;

FIGS. 7A-7C show perspective views of a retractor of the cover cleaner system having various fasteners, in accordance with some representative embodiments;

FIG. 8 illustrates a representative system that provides a suitable operating environment for use with some embodiments;

FIG. 9 illustrates a representative embodiment of a networked system that provides a suitable operating environment for use with some embodiments of the cover cleaner system;

FIG. 10 shows a perspective view of the cover cleaner system with a hanging mount (e.g., allowing the cover cleaner system to be suspended from an object, such as a door, a closet rod, or another object), in accordance with a representative embodiment; and

FIG. 11 shows a perspective view of a roller of the cover cleaner system (e.g., where the roller is adapted to receive a cover and secure the cover in place between a first arm and a second arm of the roller), in accordance with a representative embodiment.

### DETAILED DESCRIPTION

A description of embodiments of the described system will now be given with reference to the Figures. It is to be understood that the components of the described system, as generally illustrated in the Figures herein, could be arranged and designed in a wide variety of different sizes and configurations. Thus, the Figures may show simplified or partial views, and the dimensions of elements in the Figures may be exaggerated or otherwise not in exact proportion. It is expected that the described system may take many other forms and shapes. Hence, the following disclosure is intended to be illustrative and not limiting, and the scope of the system should be determined by reference to the appended claims. Additionally, while the following disclosure is grouped into subheadings, the utilization of subheadings is for convenience of the reader only and is not to be construed as limiting in any sense.

### Cover Cleaner System

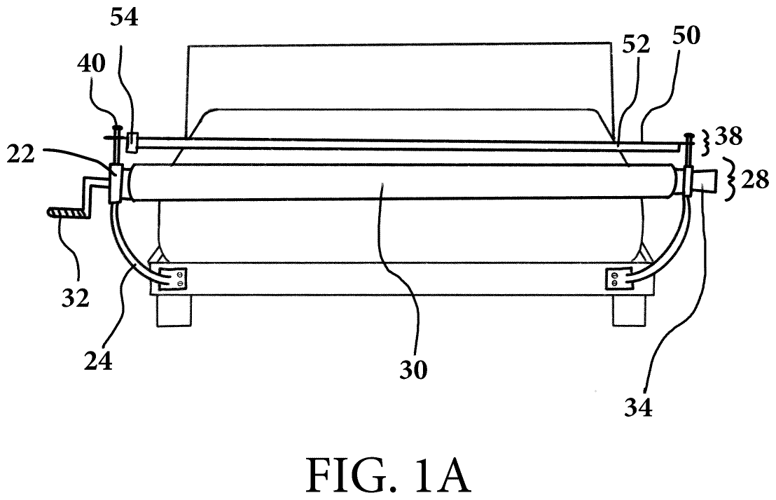

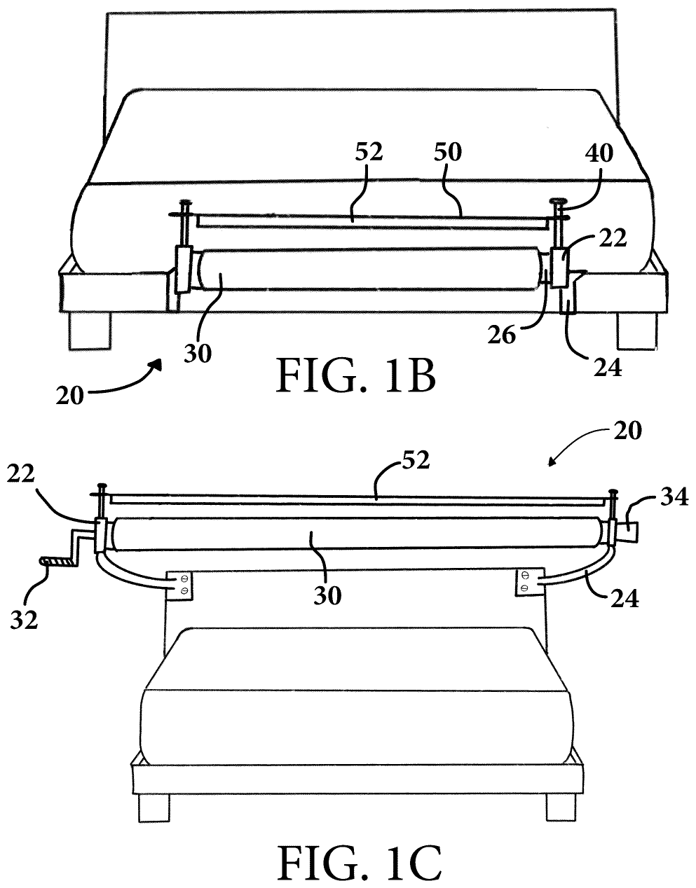

According to some embodiments, the present described system comprises a cover cleaner system 20 (or cover cleaner). In some embodiments, the cover cleaner is primarily intended to be used as a cover cleaner, but it can be used with any other suitable material or other cover. The cover cleaner can include any component that will assist allow it to store, clean, heat, cool, deodorize, sanitize, press, steam, or otherwise treat one or more covers. That said, FIGS. 1A-7C show that some embodiments of the cover cleaner 20 comprises one or more frames 22, mounts 24, support arms 26, retractors 28, rollers 30, cranks 32, motors 34, cleaners 38, connectors 40, actuators 42, support bars 50, secondary support bars 150, cleaning heads 52, secondary cleaning heads 152, debris removers 54, fasteners, clips 62, elastics 64, slits 66, heaters, misters, vibrators, bedcovers 80, magnets, or other suitable components.

According to some embodiments, the cover cleaner includes one or more frames 22. The frame can comprise any suitable frame capable of supporting, attaching, or providing structure for one or more elements of the cover cleaner. In some embodiments, the frame is relatively small, whereas in other embodiments it is larger. In some embodiments, the frame provides one or more attachment points for one or more other elements of the cover cleaner. In some embodiments, the frame includes multiple parts, such as two distinct halves, or many different pieces that can be attached together or remain separate.

According to some embodiments of the cover cleaner 20, the frame 22 includes at least one mount 24. While the mount may comprise any suitable mount that increases the convenience, security, stability, or durability of the cover cleaner, in some embodiments, the mount allows the cover cleaner to be secured to a surface (such as a surface of a floor, a wall, a ceiling, a door, a window, a bed, a desk, a cart, a shelf, or another object). For example, in some embodiments the mount is configured to be attached to part of a bed (as shown in FIGS. 1A-C). In some embodiments, the mount may be attached to a bed or another surface with nails, screws, bolts, welding, or any other suitable permanent, semi-permanent, or readily removable or releasable method of attachment. In some embodiments, the mount may be selectively attached to a bed or another surface.

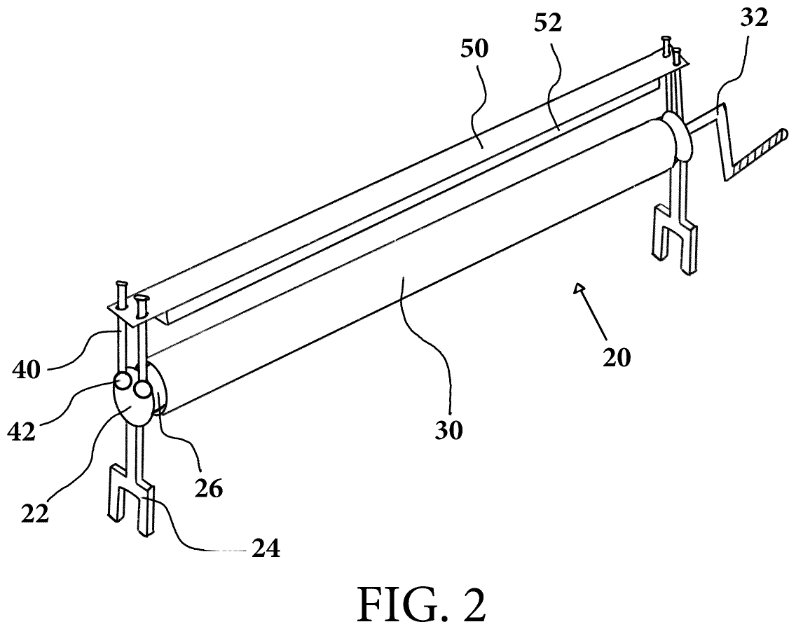

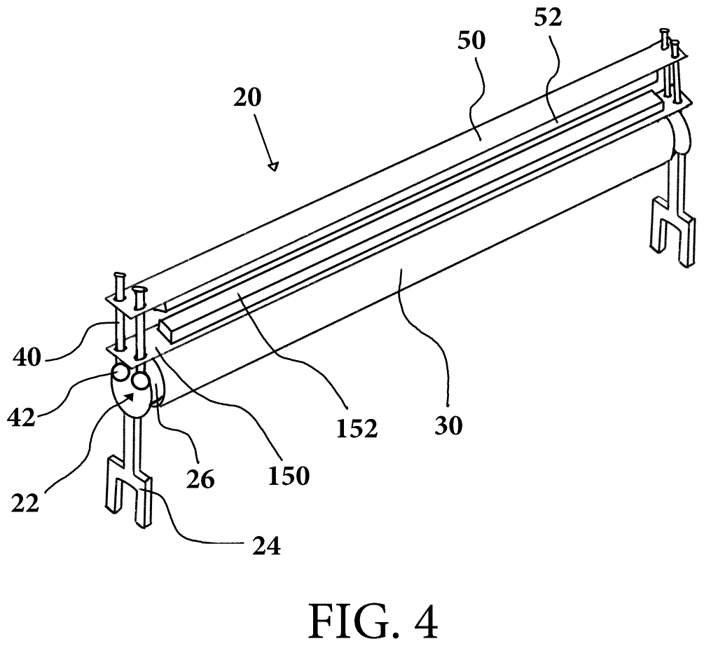

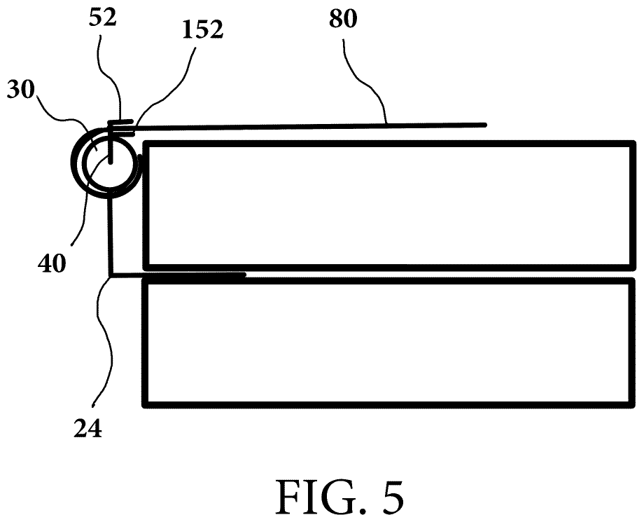

As shown in FIGS. 2 and 4, the mount 24 may be configured to allow the cover cleaner 20 to stand upright on the floor or another surface (not shown), or to be placed over a footboard, headboard, or another projection. As shown in FIG. 5, the mount 24 may allow the cover cleaner 20 to be stabilized by being placed between two or more other surfaces (e.g., two mattresses, a mattress and a box springs, a floor or wall and another surface, boards, cushions, or any other suitable surfaces).

The mount 24 may be made of or otherwise comprise any suitable material (including wood, metal, plastic, aluminum rubber, and any other material), and it may be attached to the frame in any suitable manner. In some embodiments, the mount further includes one or more hinges, springs, flexible portions, magnets, extendable pieces, or other features allows the cover cleaner to be manipulated while attached to a surface. For example, some embodiments of the mount are attached to a bed, yet configured to allow the cover cleaner to be moved underneath the bed, to the side of the bed, above the bed, or maneuvered into a position for optimal operation. Some embodiments of the cover cleaner have no mount, and in some embodiments, there is a mount, but it is selectively removeable (e.g., so the mount may remain attached to a bed or another surface, but the cover cleaner may be detached from the mount and stowed in a separate location when not in use). In some embodiments, the mount may be replaced with one or more accessories (e.g., a device for augmenting the cleaning capacity of the cover cleaner, such as a sprayer, mister, steamer, heater, colloer, ironing board, cover press, additional cleaning head, or any other suitable accessory).

As best seen in FIGS. 2 and 4, in some embodiments the frame 22 includes at least one support arm 26. While the support arm can include any component capable of providing support to another element of the cover cleaner 20, in some embodiments the support arm is configured to support one or more retractors 28, which may include one or more rollers. In some embodiments, the support arm includes one or more cylinders, connectors, shafts, dowels, wands, boards, slabs, cords, axles, or another object or objects capable of passing through a longitudinal cavity of a hollow cylinder. In some embodiments, the support arm is configured to extend a short distance into or onto one end of a retractor. In some embodiments, multiple support arms work together to support the retractor (or multiple retractors); for example, one support arm may support one end of the retractor (for example, by extending into or over that end of the retractor, clamping or pressing into that end of the retractor, or otherwise supporting that end of the retractor), and another support arm may support another end of the retractor. The support arm may support a retractor by any means, but in some embodiments it is preferred that the support arm support the retractor in a way that allows the retractor or a portion of the retractor to rotate about a longitudinal axis. As a non-limiting example, in some embodiments, the support arm includes one or more bearings (e.g., a tapered roller bearing, a rolling-element bearing, a thrust bearing, a cylinder, a needle roller bearing, a fluid bearing, a magnetic bearing, a linear-motion bearing, a ball bearing, a sphere, a pillow block bearing, or any other bearing or combination of bearings).

In some embodiments of the cover cleaner 20, the cover cleaner includes one or more retractors 28. The retractor can include any suitable device or mechanism that enables the retractor to retract a cover, such as a bedcover (or an article of clothing, a textile, or another type of cover). In some embodiments, however, the retractor retracts a cover by causing the cover to roll up from one end. In some embodiments, the retractor causes the cover to spool around a roller 30. In some embodiments, the retractor folds the cover.

Some embodiments of the retractor 28 include one or more rollers 30. Although the roller can comprise any suitable object that is capable of structurally assisting the retractor in retracting a cover, in some embodiments the roller is substantially cylindrical in form. In some embodiments, a cross section of the roller through a longitudinal axis of the roller is substantially circular. In some embodiments, a cross section of the roller through a longitudinal axis of the roller is another shape. For example, in some embodiments the roller comprises a triangular cylinder, a square cylinder, a hexagonal cylinder, a prismatic cylinder, or a cylinder of another type. In some embodiments, the roller is substantially planar.

In some embodiments having a roller 30, the roller is supported by the support arm 26 of the frame 22. In some embodiments, the roller is configured to freely rotate about a longitudinal axis while it is supported by the support arm. In some embodiments, the rotation of the roller can cause a cover to spool around the roller, thereby retracting the cover. In such embodiments, counter-rotation of the roller would thereby cause or allow the cover to unspool. In some embodiments, the roller is configured to be rotated manually, and in some embodiments, the roller is configured to be rotated automatically. In some embodiments, the roller is interchangeable or selectively detachable from the support arm, thereby allowing different types or sizes of rollers to be accommodated.

In some embodiments having a roller 30, the roller includes at least one lock. In some embodiments, the lock is configured to selectively prevent the roller from rotating about a longitudinal axis. While the lock can comprise any suitable lock capable of accomplishing this function, in some embodiments, the lock comprises one or more brakes, clamps, pins, magnets, frictional engagements, mechanical engagements, geared mechanisms, actuators, ties, straps, or another feature that is configured to allow the roller to be selectively immobilized.

As shown in FIGS. 1A, 1C, and 2, in some embodiments of the invention that have a roller 30, the roller includes at least one crank 32. While the crank can comprise any suitable object that allows a user to cause the roller 30 to rotate, in some implementations, the crank is configured to allow a user to rotate the roller by hand. In some embodiments, the crank is physically attached to the roller. In some embodiments, the crank is mechanically coupled to the roller, such as though a system of one or more gears, belts, threaded drives, or other mechanical couplers. In some embodiments, the crank has a handle. In some embodiments with a handle, the handle is configured to rotate about a longitudinal axis of the roller independently of the rest of the crank, thereby making it easier for a user to turn the crank. In some embodiments, the crank has a shaft. In some embodiments with a shaft, the shaft penetrates through the frame 22 in order to couple with the roller, whereas in other embodiments the crank is not associated with the frame. The crank may be any suitable size, shape, or configuration allowing it to perform the functions described herein.

In some embodiments having a retractor 28, the retractor includes at least one motor 34. While the motor can comprise any suitable object that enables the retractor to automatically retract a cover (e.g., a motor, a hydrostatic drive, a pneumatic drive, a belt drive, or any other type of actuator), in some embodiments, the motor is configured to automatically perform any of the functions that a crank 32 may perform as described herein. For instance, in some embodiments having a roller 30, the motor can cause the roller to selectively rotate about a longitudinal axis. Although the motor can be any type of motor that causes the retractor to retract a cover, in some embodiments, the motor comprises one or more gas motors, electric motors, brushless motors, brushed motors, direct drive motors, linear motors, stepper motors, AC motors, DC motors, or any other type of suitable motor or motors. In some embodiments, the motor includes or is otherwise in electrical contact with one or more batteries. In some embodiments, the motor includes or is electrically coupled to one or more power cords that may be plugged into a power supply (such as an outlet). While the motor can be situated anywhere on or around the cover cleaner 20 that allows the motor to accomplish any of the functions described herein, in some embodiments (as shown in FIG. 1A) the motor is mounted on the frame 22 or another location external to the retractor. However, in some embodiments (not pictured), the motor is included internally within the retractor, within the roller 30, within the frame, or within another component of the cover cleaner. Indeed, including the motor internally within the roller can reduce the bulk and increase the convenience of the cover cleaner.

Some embodiments of the cover cleaner 20 include one or more cleaners. In this regard, the cleaner can be anything capable of cleaning a cover (with “cleaning” being any function that improves the cleanliness, orderliness, appearance, comfort, or desirability of an object—such as a cover)—including, but not limited to, the following: removing pet hair, dust, dirt, debris, food crumbs, insects, dead skin, lint, spills, organic matter, bacterial matter, moisture, stains, or any other material desirable to be removed; sanitizing, sterilizing, disinfecting, or having an antimicrobial, antibacterial, antiviral, or antifungal effect; heating, pressing, ironing, steaming, cooling, smoothing, fluffing, de-wrinkling, or otherwise improving the look, feel, or texture; deodorizing or stain removal; adding materials having a pleasant aroma or texture; reducing static cling; and any other suitable process for improving the cleanliness, orderliness, appearance, comfort, or desirability of an object).

In some embodiments, the cleaner is configured to clean a cover as the cover is retracted by the retractor. For example, the cleaner may clean the cover as the cover is wound around a roller. In some embodiments, the cleaner is configured to clean a cover as the cover is extended (e.g., unspooled from the roller).

In some embodiments with a cleaner 38, the cleaner includes at least one cleaning head 52. While the cleaning head can comprise any suitable object that is capable of cleaning (or contributing to the cleaning of) a cover, in some embodiments, the cleaning head performs one or more specific cleaning functions. In some embodiments, the cleaning head includes one or more matter removers, such as one or more brushes, combs, lint removers, lint rollers, pet hair removers, hair cleaners, hair rollers, debris catchers, roller brushes, elongated brushes, adhesive-based cleaning heads, electrostatic matter removers, or any other type of matter remover or removers. In some embodiments, the cleaning head performs a different cleaning function, such as pressing, ironing, steaming, sanitizing (e.g., using UV sanitizing light, ozone, or any other type of sanitizer), perfuming, spraying, fluffing, or another cleaning function. In some embodiments, the cleaning head includes one or more vacuums. In some embodiments, the cleaning head includes one or more air blowers. In some embodiments, the cleaning head includes one or more elongated brushes configured to capture debris. In some embodiments with an elongated brush, the elongated brush comprises ABS material or any other suitable material that is capable of easily capturing pet hair or other debris. In some embodiments, the cleaning head includes one or more storage compartments for storing debris. In some embodiments, the cleaning head is configured to move debris or other matter from the cover to the storage compartment.

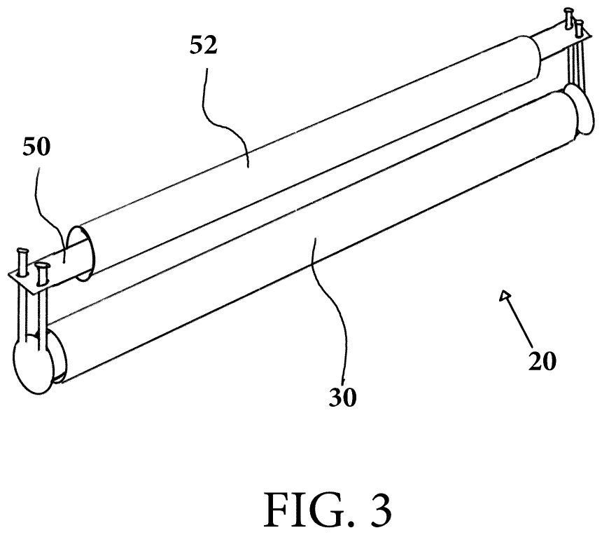

In embodiments with a cleaning head 52, the cleaning head can be of any suitable size, shape, and configuration, but in some embodiments, as shown in FIG. 2, the cleaning head can be in substantially the shape of an elongated bar. In some embodiments, as shown in FIG. 3, the cleaning head can be in substantially the shape of a cylinder. In some embodiments in which the cleaning head is substantially in the shape of a cylinder, the cylinder can be configured to rotate around a longitudinal axis. Thus, the cleaning head can roll so that different portions of the cleaning head contact different portions of a cover as the cover is retracted past the cleaning head. In some embodiments, the rotation of the cleaning head is paired with or coupled to the rotation of the roller. Accordingly, in some embodiments, the cleaning head rotates as the roller rotates (for example, in a direction opposite to or a direction that is the same as the direction of rotation of the roller).

In some embodiments with one or more cleaning heads 52, the cleaning head includes one or more cleaning elements to assist in the cleaning process. For example, in some embodiments, the cleaning head includes one or more heaters, misters, vibrators, coolers, or other cleaning elements. In some embodiments having a heater, the heater includes at least one heating element (such as a wire, hot plate (e.g., a metal plate, a ceramic plate), coil, or any other suitable heating element). In some embodiments having a heating element, the heating element extends along a length of the cleaning head. In some embodiments having a heating element, the heating element extends along a partial length of the cleaning head. In some embodiments having a mister, the mister is configured to mist or spray water, perfume, chemicals, essential oils, or any other suitable fluid onto the cover as the cover is retracted or extended. In some embodiments having a mister, the mister includes a tank for storing one or more fluids. In some embodiments having a mister, the mister includes at least one nozzle for dispensing the fluid substance. Indeed, some embodiments of the mister include a tank (e.g., any suitable containing for containing a fluid), which may be mounted on the support bar, attached to the frame 22, fluidically attached to the cover cleaner (e.g., via a hose) or included in any other suitable location. Furthermore, some embodiments of the mister include a plurality of nozzles disposed proximate to the cleaning head, on the support bar, or in any other location suitable for providing spray or mist coverage of all or part of a cover, as desired.

In some embodiments with a cleaning head 52, the cleaning head includes at least one debris remover 54. In some embodiments, the debris remover is coupled to the cleaning head. In some embodiments, the debris remover is configured to slide along a length of the cleaning head and clean the cleaning head. In some embodiments, the debris remover is configured to remove hair or other debris from the cleaning head. In some embodiments, the debris remover collects debris from the cleaning head and gathers it to a single location from which the debris can be more easily removed.

Although the cleaner 38 can have any number of cleaning heads, as shown in FIGS. 4 and 5, in some embodiments the cleaner includes one or more secondary cleaning heads 152. In some embodiments, the secondary cleaning head is situated opposite the cleaning head 52. In some embodiments, the cleaning head 52 is configured to clean a first surface of a cover, while the secondary cleaning head 152 is configured to clean a second surface of a cover. In some embodiments (as shown in FIG. 5), the cleaning head and the secondary cleaning head are so situated that the cover passes between the cleaning head and the secondary cleaning head when it is being retracted or extended. The secondary cleaning head can be of any suitable size, shape, or configuration, and can have any of the features discussed herein in connection with the cleaning head. In some embodiments, the cleaning head and the secondary cleaning head are in the same or a similar configuration, but in some embodiments the cleaning head and the secondary cleaning head are in different configurations.

In some embodiments, a first cleaning head is situated on a first location of a support bar (e.g., between the support bar and the roller), and a second cleaning head is situated on a second location of the same support bar (e.g., facing outward away from the roller). In some such embodiments, the cover may go over the support bar (e.g., so that the second cleaning head cleans a bottom side of the cover) and then wrap around the roller (e.g., so that the first cleaning head cleans a top side of the cover as the cover wraps around the roller). Thus, a single support bar can have multiple cleaning heads configured to clean opposite sides of the cover.

In some embodiments, the cover cleaner includes one or more biasing components configured to bias the cover into one or more of the one or more cleaning heads. While the biasing component can be any component that can press the cover into a cleaning head (or otherwise hold the cover in a position where the cover can be more effectively cleaned, in some embodiments, the biasing component comprises a sheet of material connected to the retractor, support rod, cleaning head, or another portion of the cover cleaner through one or more magnets, springs, screws, flexible components, or any other connecting components configured to make the biasing component effective at holding the cover in proper proximity to a cleaning head.

In some embodiments of the cover cleaner 20 having a cleaner, the cleaner includes a support bar 50. In some embodiments, the support bar supports the cleaning head 52. While the support bar may be of any suitable size, shape, or configuration to support the cleaning head, in some embodiments, the support bar comprises one or more cylinders, rods, shafts, dowels, wands, boards, slabs, cords, axles, or any other suitable object capable of spanning a distance and supporting a cleaning head. In some embodiments, the support bar is substantially in the form of an elongated planar bar. In some embodiments in which the support bar is substantially in the form of an elongated planar bar, the cleaning head is coupled to surface of the support bar. In some embodiments, the cleaning head covers multiple surfaces of the support bar or surrounds the support bar. In some embodiments, the cleaning head is configured to rotate freely around the support bar. In some embodiments, the support bar is configured to rotate.

As shown in FIG. 4, some embodiments of the cover cleaner 20 include one or more secondary support bars 150. The secondary support bar may have any suitable configuration, including any configuration of the support bar 50. In some embodiments, the secondary support bar supports the secondary cleaning head 152. In some embodiments, the support bar and the secondary support bar are in proximity to one another to thereby hold the cleaning head 52 and the secondary cleaning head in positions where the cleaning head and the secondary cleaning head can work together to more efficiently or more effectively clean a cover.

Some embodiments of the invention include at least one connector 40. Although the connector can comprise any suitable object that is capable of joining the retractor to the cleaner, in some embodiments, the connector takes substantially the form of one or more rods, pins, nails, screws, bolts, spikes, bars, extendable rods, or any other elongated elements. Although the cover cleaner 20 can include any number of connectors 40, in some embodiments, the cover cleaner includes at least two connectors, thereby allowing a connector to join the retractor to the cleaner in multiple locations (e.g., at a first end and at a second end). In some embodiments, the cover cleaner includes at least four connectors (e.g., joining the retractor to the cleaner at a first corner, a second corner, a third corner, and a fourth corner). In some embodiments, the connectors can have different lengths or be adjustable to different lengths or positions. Accordingly, in some embodiments, a distance between the cleaner and the retractor is adjustable. Moreover, in some embodiments, the precise angle of the cleaner with respect to the retractor can be adjusted and fine-tuned by adjusting different connectors to different lengths or positions. In some embodiments in which the cleaner includes one or more support bars 50 or one or more secondary support bars 150, at least one of the support bar and the secondary support bar can be coupled to one or more of the connectors. Indeed, in some such embodiments, such coupling is fixed, such that the support bar or secondary support bar is coupled to one or more of the connectors at a fixed location. In some such embodiments, however, such coupling is free, such that the support bar or secondary support bar is able to adjust to different positions along the connector(s).

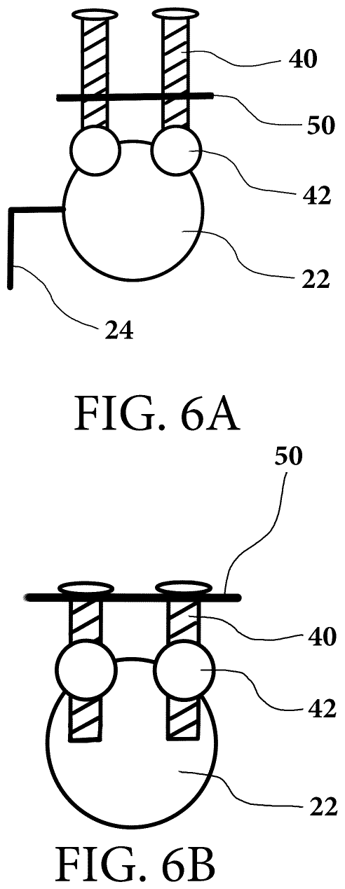

As an example of the foregoing, FIG. 6A shows a representative embodiment in which a support bar 50 is freely coupled to one or more connectors 40 in the form of bolts or screws, posts, nails, pins, or any other suitable connectors in which the support bar may move toward and away from the frame 22 while the connectors remain at a fixed height (e.g., by rotating the connectors to cause the support bar to adjust its distance from the frame due to the interaction of the support bar with the threading (or any other suitable feature) of the connectors). FIG. 6B, by contrast, shows a representative embodiment in which the support bar 50 is coupled to a pair of connectors 40 at a fixed point (at the top of the connectors), and the distance between the support bar and the frame 22 is adjusted by adjusting the position of the connectors. It bears pointing out that, like all other examples contained herein, the foregoing examples are illustrative and non-limiting. Indeed, the mechanism and method of adjusting a distance between the support bar and the frame using the connectors (if any) may be any suitable mechanism and method, including by using one or more springs (to bias the support bar toward or away from the frame), using one or more compliant connectors (such as elastics), by using one or more magnetic adjustable connectors, or by any other suitable means. Indeed, in some embodiments, some or all of the connectors may comprise one or more telescoping rods (e.g., like some radio antennae) such that the connectors extend and retract to adjust the position of the support bar without any parts of the connectors extending beyond the support bar or the retractor.

In some embodiments, the cover cleaner 20 includes one or more actuators 42. While the actuators can comprise any suitable actuators to accomplish any of the movements and adjustments discussed in the foregoing paragraphs (e.g., a motor, a hydrostatic drive, a pneumatic drive, a belt drive, or any other type of actuator), in some embodiments, the actuators are configured to adjust the position of the connectors 40 or otherwise adjust the position of the cleaner with respect to the retractor. In some embodiments, the actuators are configured to hold the cleaning head at a specific position or angle with respect to a cover. In some such embodiments, said position shifts as the cover retracts. For example, in some embodiments, the cover coils around a roller, and the radius of the cover around the roller increases as more of the cover material is spooled around the roller; thus, in order to keep the cleaning head at a fixed location with respect to the cover (in some embodiments), the distance between the cleaning head and the roller itself increases. In some embodiments, the actuators are configured to hold the cleaning head in contact with the cover (e.g., to clean the cover by brushing), but in some embodiments, the actuators are configured to hold the cleaning head a fixed distance away from the cover (e.g., in order to spray the cover with an even layer of mist or any other suitable fluid).

In some embodiments with one or more actuators 42, the actuators are configured to adjust the position of one or more support bars 50 or one or more secondary support bars 150, thereby adjusting the position of one or more cleaning heads 52 or one or more secondary cleaning heads 152, independently of one another. For example, the actuators may cause the support bar and the secondary support bar to move in opposite directions, thereby creating a gap through which a cover can be inserted; or thereby causing the support bar and the secondary support bar to come together to press, iron, brush, or otherwise clean the cover from the top and bottom (or at other opposing surfaces) simultaneously.

In embodiments with at least one actuator, each actuator 42 may be any suitable actuator, but in some embodiments one or more actuators comprise an automatic actuator such as a pneumatic, hydraulic, hydrostatic, electric, mechanical, or other actuator. In some embodiments, one or more actuator comprise one or more manual actuators (cranks, levers, dials, switches, springs, or any other suitable actuators). In some embodiments, any or all of the adjustments herein can be implemented without an actuator (e.g., through manual adjustments). In some embodiments, a single actuator operates to adjust the position of one or more support bars 50 and to cause the roller 30 to rotate and to effectuate any additional motion of the cover cleaner, whereas some embodiments include multiple actuators or motors for performing the various movement functions of the cover cleaner.

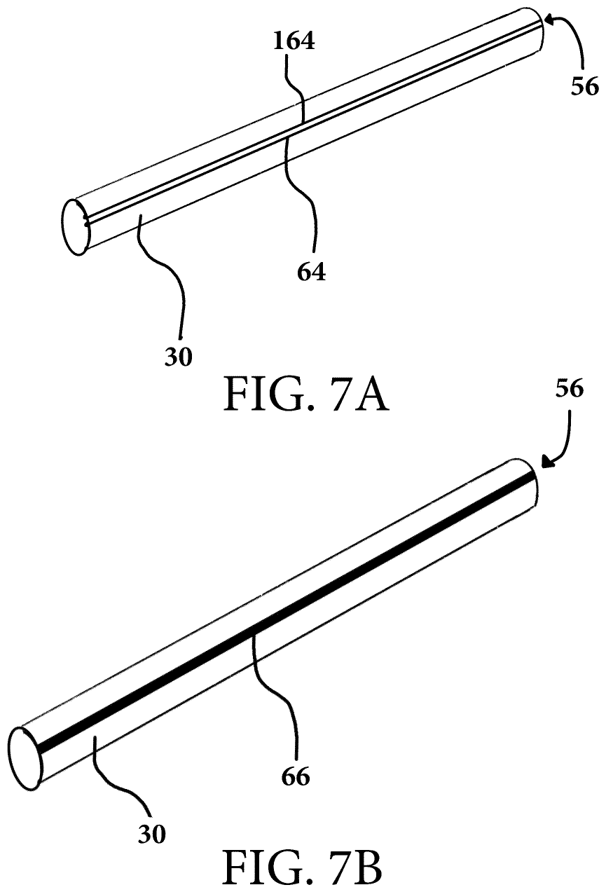

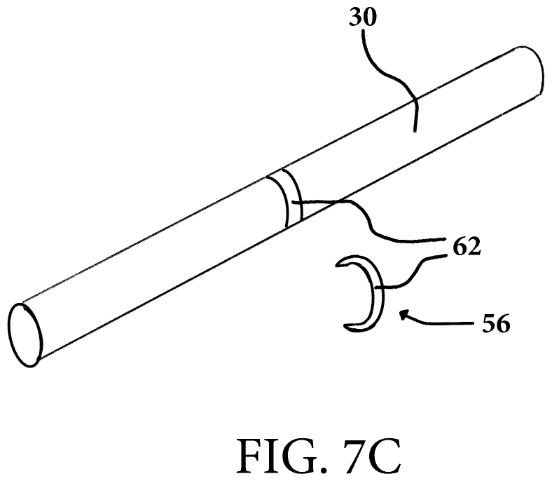

As shown in FIGS. 7A-7C, some embodiments of the cover cleaner 20 include at least one fastener 56. The fastener can include any component capable of coupling a cover to the retractor 28 (for example, by coupling the cover to the roller 30). Although the fastener may be any suitable fastener capable of coupling a cover to a roller (e.g., a clip, a pin, an elastic, a slot, a clamp, an adhesive, a bifurcated roller configured to act as a clamp, or any other coupling device), in some embodiments, the fastener comprises one or more elastics 64. Although the cover cleaner can include any suitable number of fasteners, including any number of elastics, in some embodiments, the fastener includes one or more secondary elastics 164. In some embodiments, a cover may be coupled to the roller by placing an edge of the cover underneath an elastic, underneath a secondary elastic, or between the elastic and the secondary elastic. In some embodiments, the elastic or secondary elastic may have pneumatic properties (e.g., may be filled with gas or liquid to better grip a portion of a cover). Furthermore, in some embodiments, the elastic may comprise any suitable cord, rope, bungee, hose, string, rod, sheet, strap, coupling, or any other suitable component capable of placing tension on a cover to hold it in place (whether elastic or inelastic in nature).

In some embodiments, the fastener includes one or more slits 66 in the roller. In such embodiments, a portion of the cover may be placed into the slit to hold the cover in place as the roller rotates about a longitudinal axis, thereby causing the cover to spool around the roller. In some embodiments, the fastener includes one or more clips 62 (as shown in FIG. 7C, such as a C-clip, whose form is configured to be complimentary and compliant with a portion of the roller 30 to thereby hold a cover in place). In some embodiments, the fastener includes one or more magnets, one or more metal rings spanning the length of the retractor, or an other suitable type of fastener or combination of fasteners.

Although some embodiments of the cover cleaner 20 are configured to be used with any cover, some embodiments include at least one cover 80 that is fixedly or selectively attached to the cover cleaner (e.g., to the roller).

Some embodiments include one or more extenders that are configured to extend a cover that is retracted (e.g., by unspooling it from the roller or otherwise unretracting it). Although the extender can be any suitable extender, in some embodiments, the extender comprises one or more spring bars. In some embodiments, the extender is a track along which a portion of the cover can be guided to cause it to unspool from the roller. In some embodiments, the extender is configured to remake a bed (e.g., after retracting a bedcover), hang up a towel (e.g., after cleaning the towel), or otherwise restore any cover to an un-retracted state, place the cover in condition for a subsequent use, or otherwise reset or prepare the cover following cleaning.

The cover cleaner 20 and any component thereof (as described above) can be constructed in any suitable manner, including through casting, molding, extrusion, laser cutting, extrusion, printing, deposition, compaction, spray forming, injection, forging, rolling, shearing, pressing, machining, milling, welding, sintering, additive manufacturing, 3D printing, or any other suitable method of manufacturing the cover cleaner and components thereof.

The described systems can be modified in any suitable manner. Indeed, in some embodiments, the system includes one or more ultra-violet lights to disinfect or sterilize the cover as it is retracted, stored in, or released from the system. In some embodiments, the system includes one or more steamers or irons (e.g., to help kill mites, lice, fleas, bacteria, or any other biologics on the cover; to help freshen the cover; to help remove wrinkles from the cover; or to perform any other suitable purpose).

In some embodiments, the system includes one or more brushes, chemicals, sprays, or other materials that include one or more materials that repel, kill, disorient, or otherwise help to avoid or to remove insects from the cover. Indeed, in some cases, as the cover is retracted, stored in, or released from the retractor, the cover is rubbed with, sprayed with, held adjacent to, or otherwise associated with imidacloprid, flumethrin, propoxur, fipronil, metaflumizone, pyrethroids (e.g., where the cover will be used with dogs), selamectin, amitraz, fenoxycarb, permethrin, propoxur, tetrachlorvinphos, or any other suitable material that can help keep the cover free from fleas or any other living bugs.

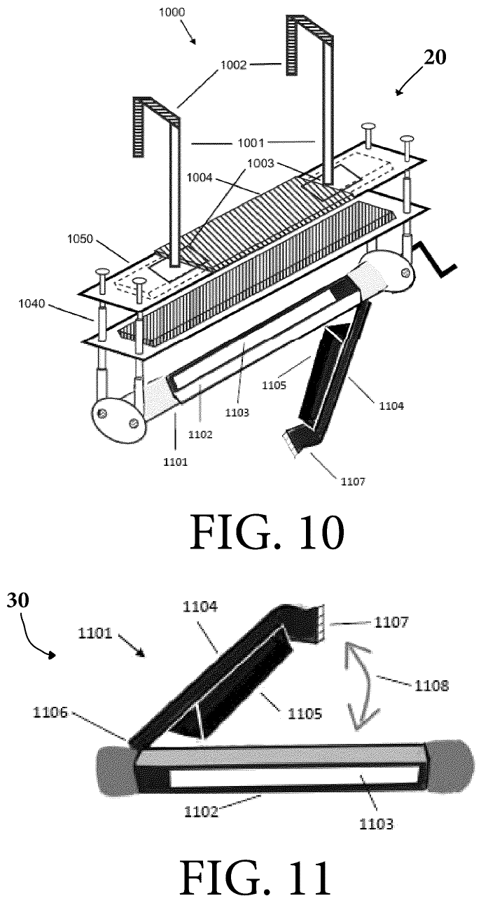

As shown in FIGS. 10-11, some embodiments of the cover cleaner 20 are configured, or can be adapted, for use with one or more smaller covers (e.g., clothing, towels, rugs, rags, wipes, or other smaller covers), or are otherwise modified for different uses. For example, some embodiments include a hanging cover cleaner 1000 configured to be mounted on a door, a shelf, a closet rod, a headboard, a frame, a peg, a fence, a nail, or any other suitable object or surface in a hanging configuration.

In some embodiments, a mount of a hanging cover cleaner 1000 may include one or more hangers 1001. The hangers can include any component suitable for hanging the cover cleaner, such as one or more hooks, ropes, cords, chains, anchors, rods, brackets, nails, straps, clips, stakes, ties, wires, nets, catches, clips, pins, straps, or any other suitable hanging devices. The hangers can be flaccid, rigid, semi-rigid, or a combination thereof. The hangers can be adapted for use with any surface. For example, the hanger may include one or more hooks 1002, such as one or more square hooks (e.g., rectangular head brackets or other square hooks for hanging the cover cleaner on the top of a door, on a headboard, or on another object with generally square edges), round hooks (e.g., for hanging the cover on a closet rod, a pipe, a clothesline, a rail, or another generally cylindrical object), or hooks of any other suitable shape. By way of non-limiting illustration, FIG. 10 shows a hanging cover cleaner 1000 with hangers 1001 that include square hooks 1002.

As with other embodiments, the mount 24 (e.g., hangers 1001) of the cover cleaner 1000 can be secured to the frame 22 in any suitable manner (e.g., as set forth above). By way of example, FIG. 10 shows the hangers 1001 secured to bases 1003 configured to be selectively coupled to a plate 1004 in order to couple the hangers to the cleaner 1050. In some embodiments, the plate includes one or more magnets or ferromagnetic materials configured to magnetically couple the bases to the cleaner.

In some embodiments, the height of the hanging cover cleaner 1000 is configured to be adjusted. In some cases, the mount (e.g., hangers 1001) are adjustable, and in some cases, the connectors 1040 are adjustable. In this regard, the height can be adjusted via any suitable mechanism, such as via telescoping, screwing, switching out different sized components, changing strap lengths, or making any other suitable adjustments (e.g., of the hangers, the connectors, or other components).

As another example of a suitable modification, in accordance with some embodiments (and as shown generally in FIGS. 10-11), some embodiments include a roller 1101 configured to open and close (e.g., like a clip). Accordingly, in some embodiments, a cover can be inserted into a gap between two halves (or parts) of the roller and secured in place by closing the roller. In some such embodiments, the roller can include a first arm 1102, a second arm 1104, and any number of additional arms, which are configured to separate from one another (such that a cover can be pinched between the arms). The roller can also include any suitable type of fasteners or any other suitable roller features, including as discussed above.

In some embodiments, at least one of the arms of the roller 1101 includes one or more grooves 1103, and another arm includes one or more tongues 1105 configured to be inserted into the corresponding groove or grooves, such that a cover inserted into the gap between the two halves (or parts) of the roller is more firmly held in place when the roller is closed.

In some embodiments, when the roller 1101 is opened, the first arm 1102 fully separates from the second arm 1104, but in some embodiments, a portion of the first arm remains coupled to the second arm, such as by one or more hinges 1106. Where a hinge is used, the hinge can include any suitable hinge mechanism, such as a butterfly hinge, a flush hinge, a tee hinge, a barrel hinge, a butt hinge, or any other suitable type of hinge capable of allowing the roller to perform an opening and closing action (e.g., as illustrated in FIG. 11 by arrow 1008). In some embodiments, the roller includes one or more latches 1007 configured to selectively couple the first arm (or a portion thereof) to the second arm (or a portion thereof). In some cases, the latch is located on an opposite end of the first arm or the second arm as the hinge.

Any element, implementation, iteration, part, or embodiment of the cover cleaner 20 or 1000 as disclosed in the Figures and as described herein can be combined in any manner with any other element, implementation, iteration, part, or embodiment described herein.

### Representative Operating Environment

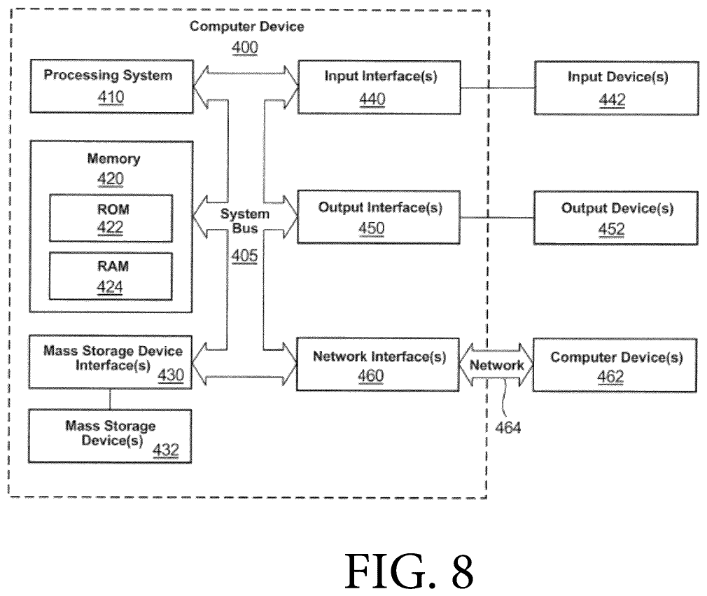

As mentioned previously, some embodiments of the described cover cleaner 20 (e.g., embodiments that comprise one or more electronically controlled heaters, coolers, misters, vibrators, motors, actuators, steamers, UV lights, or any other suitable electronically controlled mechanisms that are configured to be controlled via or operated with one or more processors) comprise one or more processors. In this regard, the described cover cleaner can be used with, or in, any suitable operating environment or software. In this regard, FIG. 8 and the corresponding discussion are intended to provide a general description of a suitable operating environment in accordance with some embodiments of the described systems and methods. As will be further discussed below, some embodiments embrace the use of one or more processing (including, without limitation, micro-processing) units in a variety of customizable enterprise configurations, including in a networked configuration, which may also include any suitable cloud-based service, such as a platform as a service or software as a service.

Some embodiments of the described systems and methods embrace one or more computer readable media, wherein each medium may be configured to include or includes thereon data or computer executable instructions for manipulating data. In accordance with some embodiments, the computer executable instructions include data structures, objects, programs, routines, or other program modules that can be accessed by one or more processors, such as one associated with a general-purpose processing unit capable of performing various different functions or one associated with a special-purpose processing unit capable of performing a limited number of functions. In this regard, in some embodiments, the processing unit comprises a specialized processing unit that is configured for use with the described cover cleaner 20.

Computer executable instructions cause the one or more processors of the enterprise to perform a particular function or group of functions and are examples of program code means for implementing steps for methods of processing. Furthermore, a particular sequence of the executable instructions provides an example of corresponding acts that may be used to implement such steps.

Examples of computer readable media (including non-transitory computer readable media) include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing unit.

With reference to FIG. 8, a representative system includes computer device 400 (e.g., one or more processors), which may be a general-purpose or special-purpose computer (or processing unit). For example, computer device 400 may be one or more processors, personal computers, notebook computers, PDAs or other hand-held devices, workstations, minicomputers, mainframes, supercomputers, multi-processor systems, network computers, processor-based consumer devices, cellular phones, tablet computers, smart phones, feature phones, smart appliances or devices, control systems, or the like.

Computer device 400 includes system bus 405, which may be configured to connect various components thereof and enables data to be exchanged between two or more components. System bus 405 may include one of a variety of bus structures including a memory bus or memory controller, a peripheral bus, or a local bus that uses any of a variety of bus architectures. Typical components connected by system bus 405 include processing system 410 and memory 420. Other components may include one or more mass storage device interfaces 430, input interfaces 440, output interfaces 450, or network interfaces 460, each of which will be discussed below.

Processing system 410 includes one or more processors, such as a central processor and optionally one or more other processors designed to perform a particular function or task. It is typically processing system 410 that executes the instructions provided on computer readable media, such as on the memory 420, a magnetic hard disk, a removable magnetic disk, a magnetic cassette, an optical disk, or from a communication connection, which may also be viewed as a computer readable medium.

Memory 420 includes one or more computer readable media (including, without limitation, non-transitory computer readable media) that may be configured to include or includes thereon data or instructions for manipulating data, and may be accessed by processing system 410 through system bus 405. Memory 420 may include, for example, ROM 422, used to permanently store information, or RAM 424, used to temporarily store information. ROM 422 may include a basic input/output system (“BIOS”) having one or more routines that are used to establish communication, such as during start-up of computer device 400. RAM 424 may include one or more program modules, such as one or more operating systems, application programs, or program data.

One or more mass storage device interfaces 430 may be used to connect one or more mass storage devices 432 to the system bus 405. The mass storage devices 432 may be incorporated into or may be peripheral to the computer device 400 and allow the computer device 400 to retain large amounts of data. Optionally, one or more of the mass storage devices 432 may be removable from computer device 400. Examples of mass storage devices include hard disk drives, magnetic disk drives, tape drives, solid state mass storage, and optical disk drives.

Examples of solid-state mass storage include flash cards and memory sticks. A mass storage device 432 may read from or write to a magnetic hard disk, a removable magnetic disk, a magnetic cassette, an optical disk, or another computer readable medium. Mass storage devices 432 and their corresponding computer readable media provide nonvolatile storage of data or executable instructions that may include one or more program modules, such as an operating system, one or more application programs, other program modules, or program data. Such executable instructions are examples of program code means for implementing steps for methods disclosed herein.

One or more input interfaces 440 may be employed to enable a user to enter data (e.g., initial information) or instructions to computer device 400 through one or more corresponding input devices 442. Examples of such input devices include a keyboard or alternate input devices, such as one or more switches, buttons, dials, timers, sensors (e.g., temperature sensors, G-force sensors, RPM sensors, color sensors, heart rate sensors, blood pressure sensors, conductivity sensors, sweat sensors, or any other suitable type of sensors, including, without limitation, those discussed elsewhere herein), digital cameras, pin pads, touch screens, mice, trackballs, light pens, styluses, or other pointing devices, microphones, joysticks, game pads, scanners, camcorders, or other input devices. Similarly, examples of input interfaces 440 that may be used to connect the input devices 442 to the system bus 405 include a serial port, a parallel port, a game port, a universal serial bus (“USB”), a firewire (IEEE 1394), a wireless receiver, a video adapter, an audio adapter, a parallel port, a wireless transmitter, or another interface.

One or more output interfaces 450 may be employed to connect one or more corresponding output devices 452 to system bus 405. Examples of output devices include a monitor or display screen, a speaker, a wireless transmitter, a printer, and the like. A particular output device 452 may be integrated with or peripheral to computer device 400. Examples of output interfaces include a video adapter, an audio adapter, a parallel port, and the like.

One or more network interfaces 460 enable computer device 400 to exchange information with one or more local or remote computer devices, illustrated as computer devices 462, via a network 464 that may include one or more hardwired or wireless links. Examples of the network interfaces include a network adapter for connection to a local area network (“LAN”) or a modem, BLUETOOTH™, Wi-Fi, a cellular connection, a wireless link, or another adapter for connection to a wide area network (“WAN”), such as the Internet. The network interface 460 may be incorporated with or be peripheral to computer device 400.

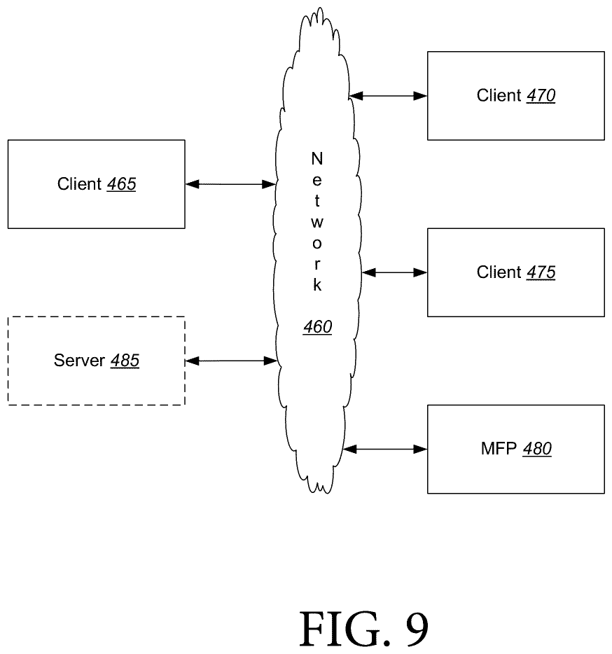

In a networked system, accessible program modules or portions thereof may be stored in a remote memory storage device. Furthermore, in a networked system computer device 400 may participate in a distributed computing environment, where functions or tasks are performed by a plurality networked computer devices. While those skilled in the art will appreciate that the described systems and methods may be practiced in networked computing environments with many types of computer system configurations, FIG. 9 represents an embodiment of a portion of the described systems (e.g., the cover cleaner 20 with one or more electronically controlled heaters, vibrators, coolers, misters, steamers, dryers, motors, actuators, or other electronically controlled components) in a networked environment that includes clients (465, 470, 475, etc.) connected to a server 485 via a network 460. While FIG. 8 illustrates an embodiment that includes three clients (e.g., the cover cleaner) connected to the network, alternative embodiments include at least one client connected to a network or many clients connected to a network. Moreover, embodiments in accordance with the described systems and methods also include a multitude of clients throughout the world connected to a network, where the network is a wide area network, such as the Internet. Accordingly, in some embodiments, the described systems and methods can allow for remote: monitoring, training, communication, observation, control, adjustment, troubleshooting, data collecting, system optimization, user interaction, or other controlling of the described cover cleaner 20 from one or more places throughout the world. Thus, for example, the cover cleaner may be preheated, cooled down, cleaned, retracted, extended, or otherwise prepared for use remotely, such as while a user is away from the user's house, or in a hotel environment while a room is vacant or being prepared to receive guests.

The described systems and methods may be embodied in other specific forms without departing from their spirit or essential characteristics. The described embodiments, examples, and illustrations are to be considered in all respects only as illustrative and not restrictive. The scope of the described systems and methods is, therefore, indicated by the appended claims rather than by the foregoing description. All changes that come within the meaning and range of equivalency of the claims are to be embraced within their scope. Moreover, any component and characteristic from any embodiments, examples, and illustrations set forth herein can be combined in any suitable manner with any other components or characteristics from one or more other embodiments, examples, and illustrations described herein.

As used herein, the term “cover” and variations thereof mean any material suitable for covering any object, including one or more pieces of fabric, canvass, plastic, metal, cotton, linen, velvet, chiffon, silk, polyester, crepe, flannel, wool, rayon, georgette, muslin, denim, organza, taffeta, damask, chenille, fleece, poplin, brocade, voile, leather, broadcloth, satin, and any other textiles or materials of any kind that may form a cover, and in any form. For example, a cover can include one or more bedcovers (e.g., any cover suitable for covering all or part of a bed, cot, couch, or other sleeping area, including one or more bedsheets, blankets, coverlets, bedspreads, comforters, quilts, duvets, silks, bug nets or other netting, and any other suitable material configured to cover a sleeping area), fabrics and textiles (e.g., silk, denim, velvet, crepe chiffon, linen, flannel, cotton, polyester, wool, fleece, broadcloth, or any other textile material), drying implements (e.g., towels, hand towels, dish cloths, washcloths, rags, cleaning towels), clothing (e.g., shirts, pants, underwear, socks, hats, scarves, and other apparel), floor covers (e.g., rugs, carpets, fleeces, mats, and other floor covers), domestic covers (e.g., couch covers, chair covers, curtains, drapes, and other household covers), rags, and other covers.

As used herein, the terms “clean”, “cleaning”, etc. are not limited to any particular method of cleaning, but instead they refer to any function that improves the cleanliness, orderliness, appearance, comfort, or desirability of an object (such as a bedcover), including, but not limited to, the following: removing pet hair, dust, dirt, debris, food crumbs, insects, dead skin, lint, spills, organic matter, bacterial matter, or any other material desirable to be removed; sanitizing, sterilizing, or having an antimicrobial, antibacterial, antiviral, or antifungal effect; heating, pressing, ironing, drying, smoothing, fluffing, de-wrinkling, or otherwise improving the look, feel, or texture; deodorizing, stain removal; adding materials having a pleasant aroma or texture; and any other process for improving the cleanliness, orderliness, appearance, comport, or desirability of an object.

As used herein, the terms “and” and “or” are nonexclusive (and therefore may be interpreted to be “and/or” unless the context clearly dictates otherwise). Additionally, the singular forms “a”, “an”, “the” and other singular references include plural referents, and plural references include the singular, unless the context clearly dictates otherwise. For example, reference to a retractor includes reference to one or more retractors, and reference to bedcovers includes reference to one or more bedcovers. In addition, where reference is made to a list of elements (e.g., elements a, b, and c), such reference is intended to include any one of the listed elements by itself, any combination of less than all of the listed elements, or a combination of all of the listed elements. Moreover, the term “or” by itself is not exclusive (and therefore may be interpreted to mean “or”) unless the context clearly dictates otherwise. Furthermore, the terms “including”, “having”, “such as”, “for example”, “e.g.”, and any similar terms are not intended to limit the disclosure, and may be interpreted as being followed by the words “without limitation”.

In addition, as the terms “on”, “disposed on”, “attached to”, “connected to”, “coupled to”, etc. are used herein, one object (e.g., a material, element, structure, member, etc.) can be on, disposed on, attached to, connected to, or otherwise coupled to another object-regardless of whether the one object is directly on, attached, connected, or coupled to the other object, or whether there are one or more intervening objects between the one object and the other object. Also, directions (e.g., “front”, “back”, “on top of”, “below”, “above”, “top”, “bottom”, “side”, “up”, “down”, “under”, “over”, “upper”, “lower”, “lateral”, “right-side”, “left-side”, “base”, etc.), if provided, are relative and provided solely by way of example and for ease of illustration and discussion and not by way of limitation.

What is claimed is:

1. A cover cleaner comprising:
a retractor configured to selectively couple with, selectively retract, and selectively release a cover; and
a cleaner coupled to the retractor and configured to clean the cover while the retractor retracts the cover.

2. The cover cleaner of claim 1, wherein the retractor comprises a roller supported by a support arm.

3. The cover cleaner of claim 1, wherein the cleaner comprises a cleaning head coupled to a support bar.

4. A cover cleaner comprising:
a frame comprising:
a support arm;
a retractor comprising:
a roller supported by the support arm; and
a cleaner coupled to the retractor comprising:
a cleaning head,
wherein the retractor is configured to selectively couple to a cover, and to selectively retract the cover by causing the cover to coil around the roller, and wherein the cleaning head is configured to clean the cover while the cover is retracted.

5. The cover cleaner of claim 4, wherein the cleaning head is coupled to a support bar.

6. The cover cleaner of claim 5, further comprising a connector configured to allow the position of the support bar to be adjusted with respect to the roller.

7. The cover cleaner of claim 6, further comprising an actuator for adjusting the position of the support bar with respect to the roller.

8. The cover cleaner of claim 4, further comprising a crank coupled to the roller, wherein when the crank is turned, the roller rotates about a longitudinal axis.

9. The cover cleaner of claim 4, further comprising a motor coupled to the roller, wherein the motor is configured to rotate the roller about a longitudinal axis.

10. The cover cleaner of claim 4, wherein the cleaning head comprises a brush.

11. The cover cleaner of claim 4, wherein the cleaning head is configured to rotate, and wherein the cleaning head is coupled to the roller such that when the roller rotates, the cleaning head rotates in a direction opposite to a direction of rotation of the roller.

12. The cover cleaner of claim 4, further comprising a fastener for attaching a cover to the roller.

13. The cover cleaner of claim 4, wherein the cleaning head comprises a component selected from at least one of a mister, an iron, a press, a dryer, a heater, a lint roller, a vacuum, and a UV sanitizing light.

14. The cover cleaner of claim 4, wherein the roller comprises a first arm and a second arm configured to selectively separate from one another and couple together with a cover at least partially disposed between the first arm and the second arm to secure the cover to the roller.

15. The cover cleaner of claim 4, further comprising a mount configured to couple the cover cleaner to an object.

16. The cover cleaner of claim 15, wherein the mount comprises a hanger configured to suspend the cover cleaner from the object.

17. A cover cleaner comprising:
a frame comprising:
a mount for coupling the frame to a surface; and
a support arm;
a retractor comprising:
a roller supported by the support arm and configured to rotate about a longitudinal axis; and
a fastener configured to selectively attach an edge of a cover to the roller; and
a cleaner comprising
a first support bar coupled to the frame by a connector;
a first cleaning head coupled to the first support bar, wherein the first cleaning head is configured to clean a first surface of the cover when the roller rotates;
a second support bar coupled to the frame by the connector; and
a second cleaning head coupled to the second support bar, wherein the second cleaning head is configured to clean a second surface of the cover when the roller rotates.

18. The cover cleaner of claim 17, further comprising an actuator configured to adjust the position of at least one of the first support bar and the second support bar with respect to the roller.

19. The cover cleaner of claim 17, further comprising a motor configured to drive the roller.

20. The cover cleaner of claim 17, wherein the first cleaning head is configured to emit ultra-violet light.
